(19) United States
(12) Patent Application Publication
(10) Pub. No.: US 2009/0157649 A1
(43) Pub. Date: Jun. 18, 2009

(54) Hybrid Method and System for Content-based 3D Model Search

(76) Inventors: Panagiotis Papadakis, Pallini (GR); Georgios Passalis, Ag. Dimitrios (GR); Ioannis Pratikakis, Argyroupoli (GR); Theoharis Theoharis, Kifisia (GR); Stavros Perantonis, Filothei (GR)

Correspondence Address: Panagiotis Papadakis, Thermopilon 13, Pallini, Attiki, 15351, GR

(21) Appl. No.: 11/957,518

(22) Filed: Dec. 17, 2007

(51) Int. Cl. G06F 7/06; G06F 17/30

(52) U.S. Cl. 707/5; 707/E17.017

(57) ABSTRACT

The present disclosure concerns a hybrid content-based 3D model search and retrieval method for queries in generic 3D model datasets. The hybrid nature of the method is two-fold. First, a combination of 2D and 3D features is used as the shape descriptor of a 3D model and second, two alternative alignment techniques, CPCA and NPCA, are employed for rotation normalization. The 2D features are Fourier coefficients extracted from three pairs of depth buffers which are computed for each Cartesian plane capturing the model's thickness along each axis. The 3D features are spherical harmonic coefficients extracted from a spherical function based representation that captures the model's surface as well as volume information.

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention describes a method and system for content-based search of generic three dimensional models, using a representation that is based on a set of hybrid features.

2. Description of the Related Art

As 3-Dimensional (3D) models are becoming an integral part of modern computer applications the need for efficient methods to manage 3D data is becoming imperative. The development of 3D model acquisition devices and advanced modeling software to facilitate the creation and manipulation of 3D models has boosted the number of 3D models available through public or proprietary repositories. Thereupon, interest has shifted to the development of methods for searching the continuously proliferating 3D content.

Content-based (or query by example) 3D model search is a procedure where a query is initiated using a 3D model that is compared against the 3D models of the dataset using a corresponding abstraction-signature which is called a shape descriptor. Thus, when the user submits a query model to the search system, the shape descriptor of the query 3D model is extracted and compared against the descriptors of all the models of the dataset to produce a sorted list of results according to a predefined measure of similarity.

Related content-based 3D model search methods may be classified in two categories, according to the similarity measurement perspective. In the first category, shape descriptors are generated from images-projections which may be contours, silhouettes, depth buffers or other kinds of 2D features. Thus the similarity is measured using 2D shape matching techniques. In the second category, shape descriptors are extracted from the 3D shape-geometry of the 3D model and the similarity is measured using appropriate 3D shape representations in the spatial domain or in the spectral domain.

The performance of methods for generic 3D model search that are based either on 2D or 3D features is limited, due to insufficient description of the shape of a 3D model by solely using one kind of feature. Performance also depends on the degree of the descriptor's invariance to the pose of a 3D model, since 3D model similarity is not considered to depend on the model's pose, i.e. on their position, scale and orientation characteristics. Related techniques that address this problem by applying pose normalization prior to feature extraction may perform well on specific classes of 3D models but not in generic 3D model datasets.

The Light Field descriptor [1] is a state-of-the-art method that belongs to the first category. It is generated by projecting the 3D model uniformly from the vertices of a dodecahedron. Each projection is composed of a combined feature vector of Zernike moments and Fourier coefficients and the distance between two models is computed by the minimal L₁ distance between all pairs of vertices under all possible rotations of the two dodecahedra. The main advantage of this method is that it does not require rotation normalization. Instead it attempts to find the best correspondence between the compared models by exhaustive searching which however poses significant time constraints. In addition, the selected 2D features exhibit good discrimination for a number of classes but seem to be inadequate for other classes.

The Gaussian Euclidean Distance Transform descriptor [2] is a state-of-the-art method that belongs to the second category. It is generated by computing the Gaussian Euclidean distance transformation of the volume of a 3D model and using the norms of spherical harmonic frequencies of the previous representation. Instead of normalizing the rotation of a 3D model, properties of spherical harmonics are used which accelerates the generation of the shape descriptor at the cost of discarding discriminating information. Thus, the selected 3D features may perform well on a number of classes but be insufficient for other.
[1] D. Y. Chen, M. Ouhyoung, X. P. Tian, Y. T. Shen, On visual similarity based 3D model retrieval, in: Computer Graphics Forum, 2003, pp. 223-232.
[2] M. Kazhdan, T. Funkhouser, S. Rusinkiewicz, Rotation invariant spherical harmonic representation of 3D shape descriptors, in: Eurographics/ACM SIGGRAPH Symposium on Geometry Processing, Aachen, 2003, pp. 156-164.

### BRIEF SUMMARY OF THE INVENTION

The present invention provides a method for representing 3D polygonal models using a novel hybrid 3D shape descriptor. The present invention also uses the novel hybrid 3D shape descriptor for the purpose of content-based search of generic 3D models from large datasets.

In one aspect of the present invention, a hybrid representation is provided that uses 2D as well as 3D features of a 3D model, in order to sufficiently capture the shape characteristics of the 3D model.

According to the specific embodiments of the method, the 2D features are Fourier coefficients, extracted from three pairs of depth-buffers which are computed for each Cartesian plane. To obtain the depth buffers, the model is first projected to the sides of a cube whose size is proportional to the scale of the model and parallel projections are combined to render the resulting depth buffers translation invariant with respect to the corresponding Cartesian axis. The number of depth buffer pairs can be arbitrary. The 3D features are spherical harmonic coefficients extracted from a spherical function based representation of a 3D model. To obtain the spherical function based representation of a polygonal model, the model is decomposed to a set of concentric spherical shells with increasing radius. Each spherical shell captures the model's surface as well as volume information within a delimited area, by a set of uniformly distributed points in longitude and latitude. The 2D and 3D features are combined to form the hybrid shape descriptor.

In another aspect of the present invention, prior to feature extraction, the model is pose-normalized by normalizing its translation, rotation and scale characteristics. To address the rotation normalization issue, two alternative alignment techniques are used in order to consider both the surface area distribution and the surface orientation distribution of the models.

According to the specific embodiments of the method, translation normalization is achieved by translating a 3D model by the vector that represents the difference between its center of mass and a reference point. Scale normalization is achieved by scaling all 3D models to a predefined size. Rotation normalization may be achieved by aligning the major axes of a 3D model, which are determined by employing principal component analysis on their model surface and/or normal vectors, with the coordinate axes in a consistent way.

In another aspect of the present invention, a search system which ranks database entries according to the similarity of a chosen query against the database entries.

According to the specific embodiments of the method, similarity is measured using the L¹ distance or another distance metric of the shape descriptors. The search system may run on a single computer platform or in client-server mode. The server may be a computer containing the list of 3D models and/or their shape descriptors and the client may be a computer which poses 3D model queries over a network; the shape descriptor for the query 3D model(s) may be computed at the client or the server.

### BRIEF DESCRIPTION OF THE SEVERAL VIEWS OF THE DRAWINGS

FIG. 1. The intermediate stages for the normalization of the pose of a 3D model; (a) Initial 3D model, (b) translation normalized 3D model, (b) rotation normalized 3D model and (d) scale normalized 3D model.

FIG. 2. Examples of rotation normalized 3D models using their surface area distribution.

FIG. 3. Examples of rotation normalized 3D models using their surface orientation distribution.

FIG. 4. (a) An example 3D model of a truck and (b) the corresponding three pairs of depth buffers computed for each Cartesian plane.

FIG. 5. The Discrete Fourier Transform of a depth buffer.

FIG. 6. (top) An example aeroplane 3D model, (middle) the representation of its surface as a set of spherical functions f₁, . . . , f_{N} and (bottom) the representation of its surface as well as of volume parts as a set of spherical functions f₁′, . . . , f_{N}′.

FIG. 7. Furthest intersections of a 3D model's surface with rays emanating from the origin (white spheres) and points closer to the origin than the furthest intersection point at each ray (dark grey spheres).

FIG. 8. The system for searching 3D models within a dataset based on a query 3D model using the hybrid method.

FIG. 9. Comparison among the LF, SH-GEDT and the proposed method (hybrid) using precision recall diagrams for: (a) the MPEG-7 dataset; (b) the PSB test dataset; (c) the NTU dataset.

FIG. 10. (a) Scores of the proposed hybrid descriptor with respect to the Average First and Second Tier and Mean Average Dynamic Recall measures and comparison with the top 3 methods in SHREC 2006 and (b) the 10 closest matches for 5 queries of SHREC 2006.

### DETAILED DESCRIPTION OF THE INVENTION

For the purpose of content-based search of 3D models, a 3D model is represented using a corresponding signature, i.e. a feature vector, which is called a shape descriptor. A shape descriptor describes the characteristics of a 3D model by a set of features which are represented by numerical values. To estimate the similarity between two 3D models, their corresponding shape descriptors are compared using a predefined measure of similarity.

In the following, the method for the computation of the hybrid 3D shape descriptor consisting of 2D and 3D features is given.

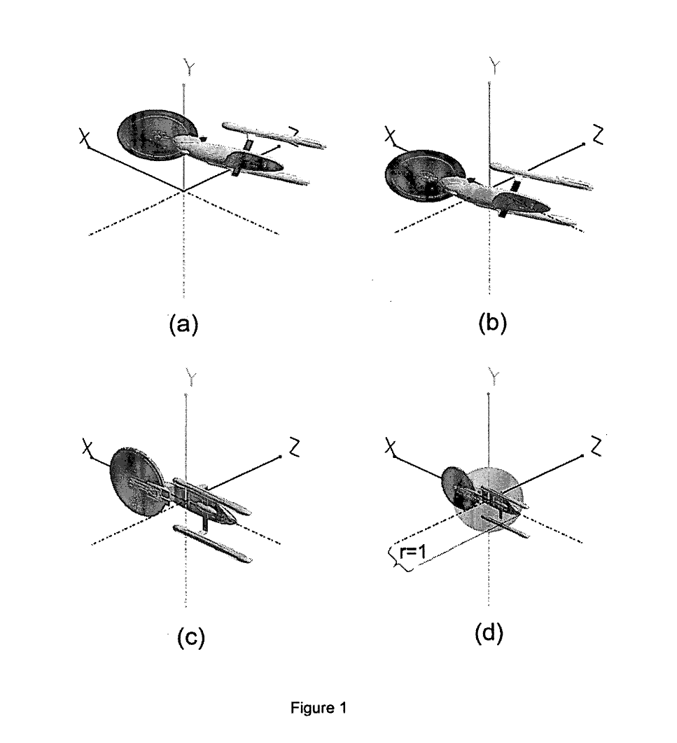

Before the extraction of the hybrid features, it is necessary to normalize the pose parameters of a 3D model (position, orientation and size) as these are arbitrarily set and are not considered to affect the shape similarity of 3D models. Thereupon, the final 3D shape descriptor should be invariant under translation, rotation and scaling. To address this issue, the following steps are followed prior to the extraction of the 3D shape descriptor: (i) Translation normalization, (ii) Rotation normalization and (iii) Scale normalization. FIG. 1(a) shows an aeroplane 3D model, FIG. 1(b) shows the translation normalized model, FIG. 1(c) shows the rotation normalized model and FIG. 1(d) shows the scale normalized 3D model.

The translation normalization step positions a 3D model in a canonical coordinate frame such that the centroids of all 3D models coincide. Thereupon, each model is translated so that its centroid coincides with the coordinates' origin. We compute the centroid m of a polygonal model using the Continuous Principal Component Analysis (CPCA). For a 3D polygonal model, the centroid m is computed as:

$$m = \frac{1}{E} {\sum }_{i = 1}^{N} {E}_{i} \cdot ( {A}_{i} + {B}_{i} + {C}_{i} ) / 3 \qquad ( 1 )$$

where E is the total surface area of the 3D model, Eᵢ is the surface area of the i^{th} triangle, N is the number of triangles and Aᵢ, Bᵢ and Cᵢ are the vertices of the i^{th} triangle. If v is a vertex of the initial polygonal model, then the translated vertices v′ of the model are given by v′=v−m. This of course is also applicable to surface models that are built out of elementary components that are not triangles.

The aim of the rotation normalization step is to rotate each 3D model in such a way that when comparing two 3D models, their surfaces will coincide as much as possible with respects to all possible relative rotations. Since a single rotation normalization method would have limited performance at aligning generic 3D models, two alternative rotation normalization methods are used in a parallel fashion.

The first method, Continuous Principal Component Analysis (CPCA), considers the distribution of the surface area of a 3D model, taking as input the vertices of the triangles of the polygonal model. Then the PCA algorithm is applied to find the principal directions of the model's surface and rotate the model so that these directions coincide with the coordinate axes.

We use CPCA to compute the covariance matrix C of the model's surface, as follows:

$$C = \frac{1}{12 E} {\sum }_{i = 1}^{N} {E}_{i} \cdot [ f ( {A}_{i} ) + f ( {B}_{i} ) + f ( {C}_{i} ) + 9 \cdot f ( ( {A}_{i} + {B}_{i} + {C}_{i} ) / 3 ) ] \qquad ( 2 )$$

where f(v)=(v−m)(v−m)^{T} and v is a vertex of the translation normalized 3D model.

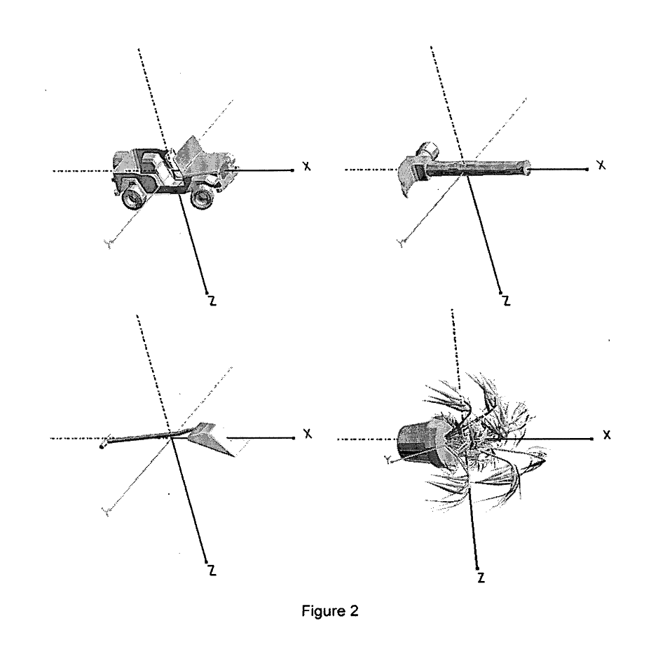

In the following, the eigenvectors of matrix C are computed, which represent the principal directions of the model's surface area. These vectors are then sorted according to the order of descending (or ascending) eigenvalues and are finally normalized to the Euclidean unit norm. A rotation matrix R is formed having as columns the scaled eigenvectors in descending (or ascending) order and R is applied to the model so that the principal directions of the model coincide with the coordinate axes. FIG. 2 shows a set of rotation normalized 3D models using the CPCA method.

The second method, Normals PCA (NPCA), considers the distribution of the surface orientation of a 3D model, taking as input the normal vectors of the model's triangles. The PCA algorithm is then applied as with the first method.

If nᵢ is the normal vector of triangle Tᵢ and m_{NI} is the mean normal vector of all triangles, then the covariance matrix is computed as:

$$C = \frac{1}{2 E} {\sum }_{i = 1}^{N} ( {E}_{i} ( {n}_{i} - {m}_{Nl} ) \cdot {( {n}_{i} - {m}_{Nl} )}^{T} + {E}_{i} ( - {n}_{i} - {m}_{Nl} ) \cdot {( - {n}_{i} - {m}_{Nl} )}^{T} ) \qquad ( 3 )$$

Each triangle is counted twice, using (i) its normal and (ii) opposite to the normal directions. This is done to avoid possible variations in the vertices ordering at the model triangles, that affects the direction's sign and because we may assume that every triangle has two sides with opposite directions. Adopting this, the mean normal vector m_{NI} becomes:

$${m}_{Nl} = \frac{1}{2 E} {\sum }_{i = 1}^{N} ( {E}_{i} \cdot {n}_{i} + E \cdot ( - {n}_{i} ) ) = 0 \qquad ( 4 )$$

The above equation indicates that m_{NI} is always the zero vector, thus C is now given by:

$$C = \frac{1}{2 E} {\sum }_{i = 1}^{N} ( {E}_{i} \cdot {n}_{i} \cdot {n}_{i}^{T} + {E}_{i} \cdot ( - {n}_{i} ) \cdot {( - {n}_{i} )}_{i}^{T} ) ) = \frac{1}{E} {\sum }_{i = 1}^{N} {E}_{i} \cdot {n}_{i} {n}_{i}^{T} \qquad ( 5 )$$

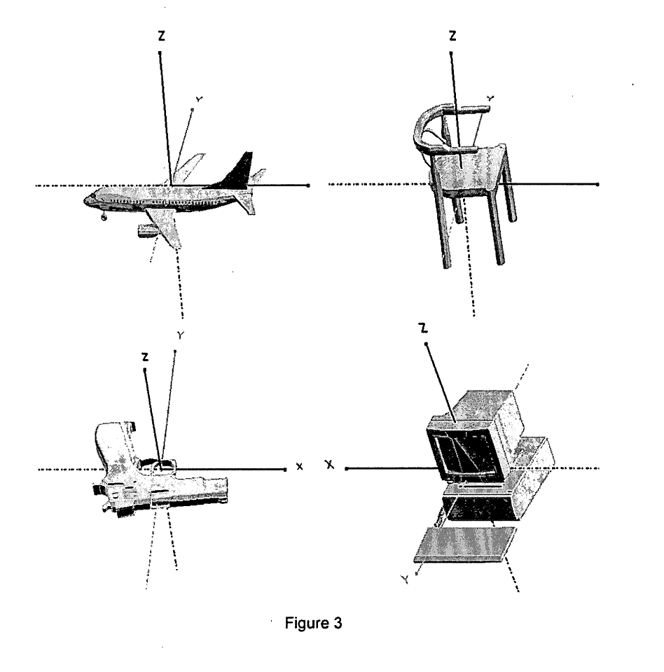

After the computation of C, the PCA algorithm is applied to find and align the principal axes of the model with the coordinate axes. In particular, the eigenvectors of matrix C are computed, which represent the principal directions of the model's surface orientation. These vectors are then sorted according to the order of descending (or ascending) eigenvalues and are finally normalized to the Euclidean unit norm. A rotation matrix R is formed having as columns the scaled eigenvectors in descending (or ascending) order and R is applied to the model so that the principal directions of the model coincide with the coordinate axes. FIG. 3 shows a set of rotation normalized 3D models using the NPCA method.

At the scale normalization step, 3D models are scaled to a normalized size where the mean distance of the surface of the model to its centroid is equal to 1. The mean distance dₘₑₐₙ is calculated using the diagonal elements of the covariance matrix which was computed at the rotation normalization step for CPCA. From the definition of the covariance matrix, the elements of the diagonal represent the variance of the distance of the model's surface from the x, y and z coordinate axes, thus dₘₑₐₙ is given by:

dₘₑₐₙ=\sqrt{C₁₁^{CPCA}+C₂₂^{CPCA}+C₃₃^{CPCA}} (6)

where Cᵢⱼ^{CPCA} is the (i,j) element of the covariance matrix computed using CPCA. The new vertices v″ of a 3D model are now given by v″=v′/dₘₑₐₙ.

After the completion of the pose normalization step, there are two pose normalized versions of the 3D model corresponding to the CPCA and the NPCA aligned version. The hybrid (2D and 3D) features are extracted for the CPCA aligned version and the NPCA aligned version. First the hybrid features are extracted for the CPCA aligned version of the model and next for the NPCA aligned version.

In the following, the detailed description for the extraction of the 2D features component of the hybrid features set is given.

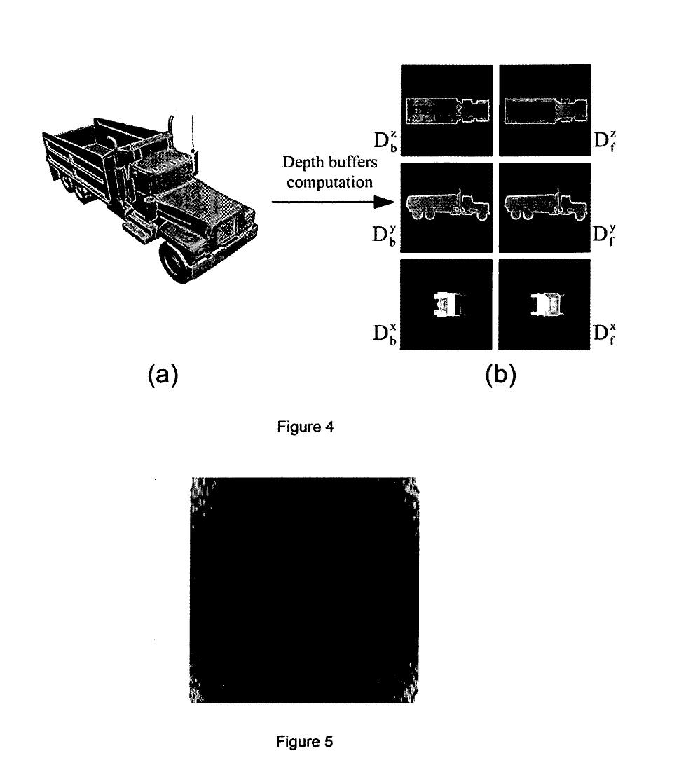

The first step is to acquire a set of depth buffers from the polygonal representation of the 3D model. A depth buffer is a regular grid of scalar values that holds the distance between a given clipping plane and the model's surface. We acquire six depth buffers, by rendering the model using an orthographic projection which uses as clipping planes the faces of a cube centered at the origin. A constant sized cube is used which means that a 3D model may not necessarily lie completely inside the cube. This approach is better than using the bounding cube where the 3D model may be contained in small resolution inside the cube, in the presence of outlying parts of the model. The edge of the cube is set to a fixed value such that the majority of 3D models lies completely inside the cube, while having large enough scale to produce descriptive depth buffers. FIG. 4(a) shows a 3D model of a truck and FIG. 4(b) shows the corresponding pairs of depth buffers computed by projecting the 3D model to the 6 six faces of the cube.

Instead of using directly the back D_{b} and front D_{f} depth buffers along each direction, we use their difference D_{dif}=D_{f}−D_{b} and their sum Dₛᵤₘ=D_{f}+D_{b}. The two new depth buffers (D_{dif}, Dₛᵤₘ) require the same storage space as the original two (D_{f}, D_{b}) and there is no information gain or loss since we can produce the one pair from the other. The difference lies in the fact that the D_{dif}, holds the thickness of the model at each pixel, which is a characteristic of the model. This value is insensitive to errors in the translation of the model along the direction of projection, thus alleviating errors introduced in the translation normalization step. Dₛᵤₘ has no physical meaning and it is used only as a complement to D_{dif} and therefore is considered less important. This is reflected on the weight selection as shown later.

To produce the 2D features, a spectral transformation is applied to each pair of depth buffers along each direction. The discrete 2D Fourier transform (DFT) of a depth buffer D of resolution S×S denoted as (F_{d}) is given by:

$${F}_{d} ( m , n ) = {\sum }_{x = 0}^{S - 1} {\sum }_{y = 0}^{S - 1} D ( x , y ) exp ( - j2π \frac{mx + ny}{S} ) \qquad ( 7 )$$

FIG. 5 shows the image of the DFT of a depth buffer. As-it can be seen, most information is concentrated on the four corners of the image of the DFT. For an S×S depth buffer we keep K×K coefficients as follows:

F(m,n)=|F_{d}(m,n)|+|F_{d}(m,S−n−1)|+|F_{d}(S−m−1,n)|+|F_{d}(S−m−1,S−n−1)| (8)

for m, n=0,1, . . . K−1, where we sum the norm of the coefficients from all four corners in order to have a reflection invariant representation. The values of S, K are set based on the desired trade-off between the level of detail captured by the shape descriptor and the required computation time. Using a resolution higher than S=128 or K=50, does not add a noticeable gain in discriminative power.

After normalizing the coefficients to the unit L₁ norm, we apply individual weights on the DFT coefficients such that the lower frequencies are assigned higher weights because they are considered to have more information, while higher frequencies are assigned lower weights because they are more sensitive to noise. Thus, the Fourier coefficients are weighted according to the following formula:

$${F}^{′} ( m , n ) = \frac{2 K - m - n}{2 K} \cdot F ( m , n ) \qquad ( 9 )$$

A final weighting is applied to the Fourier coefficients of the pairs of depth buffers, based on the following observation. Each pair of depth buffers is perpendicular to a specific coordinate axis and encodes information from two of the principal directions of a 3D model which are computed from the rotation normalization step. Since, the principal directions are sorted according to their degree of significance, we could assert that a pair of depth buffers encodes an amount of information proportional to the principal directions that it encodes, thus the coefficients of the corresponding depth buffers are weighted according to this idea. The respective weights are set to fixed values. In particular, if wᵢⱼ is the weight applied to the coefficients encoding the i^{th} and j^{th} principal direction then w₁₂=3, w₁₃=2 and w₂₃=1 for the D_{dif} coefficients and w₁₂=1, w₁₃=0.7 and w₂₃=0.3 for the Dₛᵤₘ coefficients. The final 2D feature set is the concatenation of the coefficients of the six depth buffers.

In the following, the detailed description for the extraction of the 3D features component of the hybrid features set is given.

We extract the 3D features based on a representation of a 3D model by a set of spherical functions. A spherical function describes a bounded area of the model, defined by a lower and an upper radius which delimit a spherical shell. This shell is the area in which the underlying surface of the model is represented by the equivalent spherical function points. The region corresponding to the r^{th} spherical function is the spherical shell defined in the interval [Iᵣ, Iᵣ+1) where the Iᵣ boundary is given by:

$${l}_{r} = \{ \begin{matrix}0 , & r = 1 \\ ( r - 0.5 ) \cdot M \cdot {d}_{avg} / N , & 1 < r \leq N + 1\end{matrix} \qquad ( 10 )$$

where M is a weighting factor that determines the radius of the largest sphere and N is the number of spherical functions. Multiplying by M ensures that the majority of 3D models lies completely inside the shell with the largest radius while having large enough scale to give descriptive 3D features. Therefore, the value of M is set to half the length of the edge of the cube which was used in the 2D features extraction step, to compute the depth buffers. The number of spherical functions N, is set based on the desired trade off between the level of detail that is captured and the required computation time. Using more than N=35 spherical functions has not significant effect in discriminative power.

The representation of a 3D model as a set of spherical functions is similar to projecting approximately equidistant parts of the 3D model to concentric spheres of increasing radius. This is done by computing the intersections of the surface of the model with rays emanating from the origin in the (θⱼ,φₖ) directions, denoted as ray(θⱼ,φₖ), where θⱼ represents the latitude and φₖ the longitude coordinate. The θⱼ and φₖ define the samples of the 3D model in the spherical domain where j, k=0,1, . . . 2B−1 and B is the sampling bandwidth and samples are taken uniformly along each coordinate. In the direction of ray(θⱼ,φₖ) inside the spherical shell r, we compute all the intersections of the model's surface with this ray. The value of the respective spherical function point is set to the distance of the furthest intersection point within the boundaries of the r^{th} spherical function, or to zero if there is no intersection. Thus, if l(r,θⱼ,φₖ) denotes the distance of the furthest intersection point along ray(θⱼ,φₖ) within the boundaries of the r^{th} spherical function, then the N spherical functions representing the 3D model are given by:

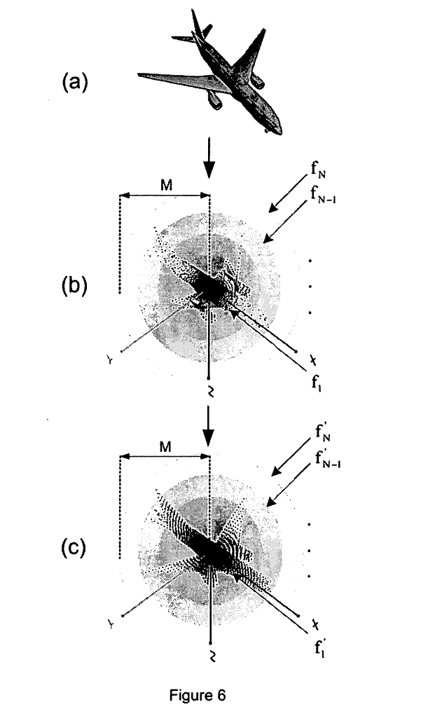

fᵣ(θⱼ,φₖ)=I(r,θⱼ,φₖ) (11)

where fᵣ: S²→[lᵣ,lᵣ₊₁)∪{0}, r=1,2, . . . ,N and S² denotes the points (θⱼ,φₖ) on the surface of the unit sphere. FIG. 6(a) shows an example 3D model of an aeroplane and FIG. 6(b) shows the corresponding fr spherical functions where each intersection point is depicted as a black dot.

In the following, the spherical functions are expanded to include additional information. Let l(D,θⱼ,φₖ), corresponding to the furthest intersection point on ray(θⱼ,φₖ), be assigned to the spherical function point f_{D}(θⱼ,φₖ). Then all fᵣ(θⱼ,φₖ), where r<D are assigned values by setting:

$${f}_{r} ( {θ}_{j} , {φ}_{k} ) = r \cdot \frac{M}{N} , ∀ r < D \qquad ( 12 )$$

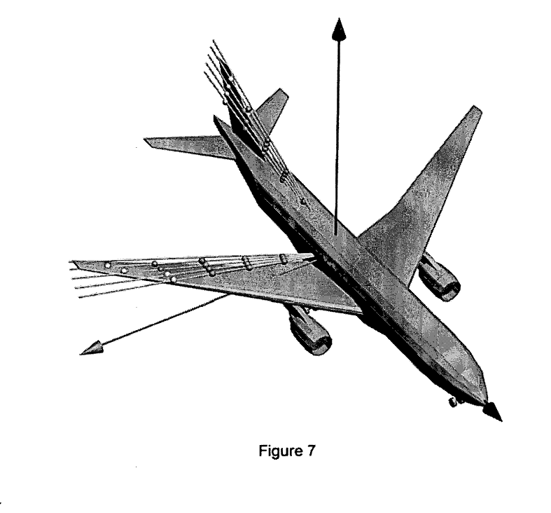

which essentially stands for the intersections of ray(θⱼ,φₖ) with all the spheres of radius less than D. These points that are included in the spherical functions using the previous equation are depicted in FIG. 7 as dark gray spheres, for a subset of rays (θⱼ,φₖ).

Practically, if the model is viewed from the (θⱼ,φₖ) direction then the part of the model along ray(θⱼ,φₖ) which is closer to the origin than l(D,θⱼ,φₖ) is occluded by the intersection point corresponding to l(D,θⱼ,φₖ). We assume here that the occluded part belongs to the model because we perceive 3D models as solid entities. Note that this representation may include points that are not in the model's volume. However the inclusion of these points significantly improves the discriminative power of the 3D features component of the hybrid shape descriptor. The new spherical functions are denoted as:

$${f}_{r}^{′} ( {θ}_{j} , {φ}_{k} ) = \{ \begin{matrix}I ( r , {θ}_{j} , {ϕ}_{k} ) , I ( D , {θ}_{j} , {ϕ}_{k} ) \neq 0 and r = D \\ \frac{r}{N} \cdot M , I ( D , {θ}_{j} , {ϕ}_{k} ) \neq 0 and r < D \\ 0 , otherwise\end{matrix} \qquad ( 13 )$$

The spherical functions are depicted in FIG. 6(c).

In the final step we compute the 3D features as the spherical harmonic coefficients of each spherical function. A spherical function f(θ,φ) can be expressed by spherical harmonic functions as:

$$f ( θ , φ ) = {\sum }_{l = 0}^{∞} {\sum }_{m = - l}^{l} \hat{f} ( l , m ) \cdot {Y}_{l}^{m} ( θ , φ ) \qquad ( 14 )$$

where \hat{f}(l,m) corresponds to the l^{th} degree and m^{th} order spherical harmonic coefficient and Yₗ^{m}(θ,φ) corresponds to the equivalent spherical harmonic function that equals to:

Yₗ^{m}(θ,φ)=k_{l,m}·Pₗ^{m}(cos θ)e^{imφ} (15)

where k_{l,m} is a normalization constant and Pₗ^{m}(cos θ) is the associated Legendre polynomial of degree l and order m. The normalization constant k_{l,m} is equal to:

$${k}_{l , m} = \sqrt{\frac{2 l + 1}{4 π} \cdot \frac{( l - m ) !}{( l + m ) !}} \qquad ( 16 )$$

Each coefficient \hat{f}(l,m) equals to the projection of the spherical function f(θ,φ) to the equivalent spherical harmonic function, that is:

$$\begin{matrix}\hat{f} ( l , m ) = < f ( θ , φ ) , \\ = {Y}_{l}^{m} ( θ , φ ) >= {k}_{l , m} \cdot {\int }_{0}^{π} [ {\int }_{0}^{2 π} f ( θ , φ ) \cdot {e}^{- i m φ} d φ ] \\ {P}_{l}^{m} ( cos θ ) \cdot sin θ d θ\end{matrix} \qquad ( 17 )$$

In our case that we consider band-limited functions, the following theorem to compute the Spherical Harmonics Transform (SHT) is useful:

### Theorem 1

Let f∈L²(S²) have bandwidth B. Then for each |m|≦l<B:

$$\hat{f} ( l , m ) = \frac{\sqrt{2 π}}{2 B} {\sum }_{j = 0}^{2 B - 1} {\sum }_{k = 0}^{2 B - 1} {a}_{j}^{( B )} f ( {θ}_{j} , {φ}_{k} ) {e}^{- i m {φ}_{k}} {P}_{l}^{m} ( cos {θ}_{j} ) \qquad ( 18 )$$

where θⱼ=(2j+1)π/(4B), φₖ=2πk/(2B) and weights aⱼ^{(B)} play an analogous role with the sin θ factor in Eq. 17.

We compute the spherical harmonic transformation of the spherical functions at constant bandwidth B for all 3D models and choose to store only the spherical harmonic coefficients up to the L^{th} degree where L<B, since spherical harmonics of higher degree do not provide additional discriminative information and are more sensitive to noise. The sampling bandwidth B as well as the maximum degree L are set based on the desired trade off between the level of detail that is captured and the required computation time. Setting these values higher than B=80 or L=20 do not significantly improve discriminative power.

Using properties of spherical harmonics we can ensure axial flipping invariance. Flipping a model with respect to a coordinate axis may only change the sign of the real or the imaginary part of a spherical harmonic coefficient; thus the absolute values are used.

After normalizing the coefficients to the unit L₁ norm, we weigh each coefficient in proportion to its degree, since spherical harmonic coefficients are Fourier coefficients. We apply this weighting based on the same principle as with the 2D features weighting of lower and higher frequency Fourier coefficients. The final 3D features component of the shape descriptor is the concatenation of the spherical harmonic coefficients of the N spherical functions.

In the following, the method for comparing the shape descriptors of two models is given.

As highlighted in the rotation normalization step, the 2D and 3D features are computed for two rotation normalized versions of a model (CPCA and NPCA). Thus the final 3D shape descriptor sᵢ of a model i is the concatenation of the 2D and 3D features for each alignment variant of the 3D model, giving:

sᵢ=(2Dfᵢ^{CPCA}, 2Dfᵢ^{NPCA}, 3Dfᵢ^{CPCA}, 3Dfᵢ^{NPCA}) (19)

where 2Dfᵢ^{k}, 3Dfᵢ^{k} are the 2D and 3D features components respectively of sᵢ using the aligned version k. To compare the descriptors s₁ and s₂ of two models we adopt the following schema to compute their distance:

Dist(s₁,s₂)=dist(2Df)+dist(3Df) (20)

where dist(2Df) and dist(3Df) denote the distances between the 2D and 3D features, respectively, given by:

$$\begin{matrix}dist ( 2 Df ) = {min}_{j} ( {L}_{1} ( 2 {Df}_{1}^{j} , 2 {Df}_{2}^{j} ) ) , \\ dist ( 3 Df ) = {min}_{j} ( {L}_{1} ( 3 {Df}_{1}^{j} , 3 {Df}_{2}^{j} ) ) , j ∈ \{ C P C A , N P C A \}\end{matrix} \qquad ( 21 )$$

where L₁ denotes the Manhattan distance between the respective features. To compute the overall distance Dist(s₁,s₂), the individual distances dist(2Df) and dist(3Df) must first be normalized to the [0,1] space.

The notion of taking the minimum L₁ distance of the features between the two aligned versions is based upon the premise that the optimal alignment method would give the best fitting-overlap of the models' surfaces. This would result in minimum distance between the respective features since the hybrid descriptor is based on the establishment of correspondences between models, which implies that the similarity of two models is proportional to their surface fitting-overlap. Therefore, we compare two models for both alignment techniques and decide that the best fitting of the models' surfaces is achieved when using the alignment method that gives the minimum distance between the features.

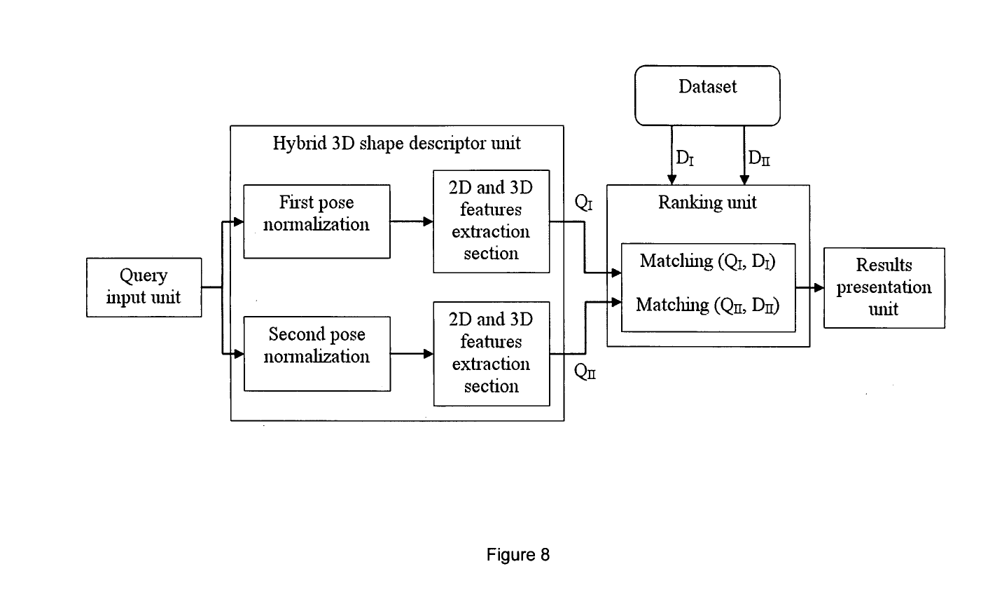

In the following, we describe the system which searches 3D models within a dataset based on a query 3D model, as shown in FIG. 8.

The search procedure is initiated when the user inputs a query 3D model to the system, using the input unit. In order to compare the query 3D model against the models of the dataset, the hybrid 3D shape descriptor extraction unit computes the shape descriptor of the query 3D model. The hybrid 3D shape descriptor consists of two sets of hybrid (2D and 3D) features which are computed for each pose normalized versions of the 3D model. Then the ranking unit compares the descriptor of the query against the descriptor of each 3D model of the dataset, by matching the hybrid features of the respective pose normalized versions, giving a measure of the distance between the query and each 3D model of the dataset. Then the results presentation unit shows the 3D models of the dataset in a sorted list where the 3D models are sorted in decreasing order of their similarity to the query 3D model.

In the following, the results of an evaluation are provided that demonstrate the superior performance of the proposed hybrid method against other state-of-the-art methods. The following 3D model datasets designed for benchmarking purposes were used:
i. The MPEG-7 dataset that includes 1300 models classified in 102 classes
ii. The Princeton Shape Benchmark test dataset (PSB) that includes 907 models classified in 92 classes.
iii. The portion of classified 3D models of the National Taiwan University 3D Model benchmark dataset (NTU) that includes 549 models classified in 47 classes.

Each 3D model of each dataset was used as the query in turn. The quality of the results was evaluated by counting the number of relevant models retrieved. The classification of relevant and irrelevant models is provided with each dataset.

The hybrid method that is presented in the disclosure is compared against the following state-of-the-art methods:
i. The Light Field descriptor (LF).
ii. The Spherical Harmonic representation of the Gaussian Euclidean Distance Transform descriptor (SH-GEDT).

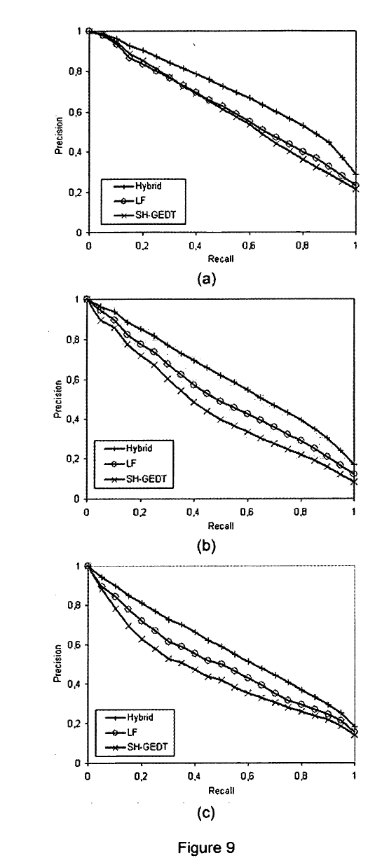

FIG. 9 gives precision-recall diagrams comparing the proposed method against LF and SH-GEDT on the specified model datasets.

The results clearly show that the proposed method outperforms previous methods on all tested datasets.

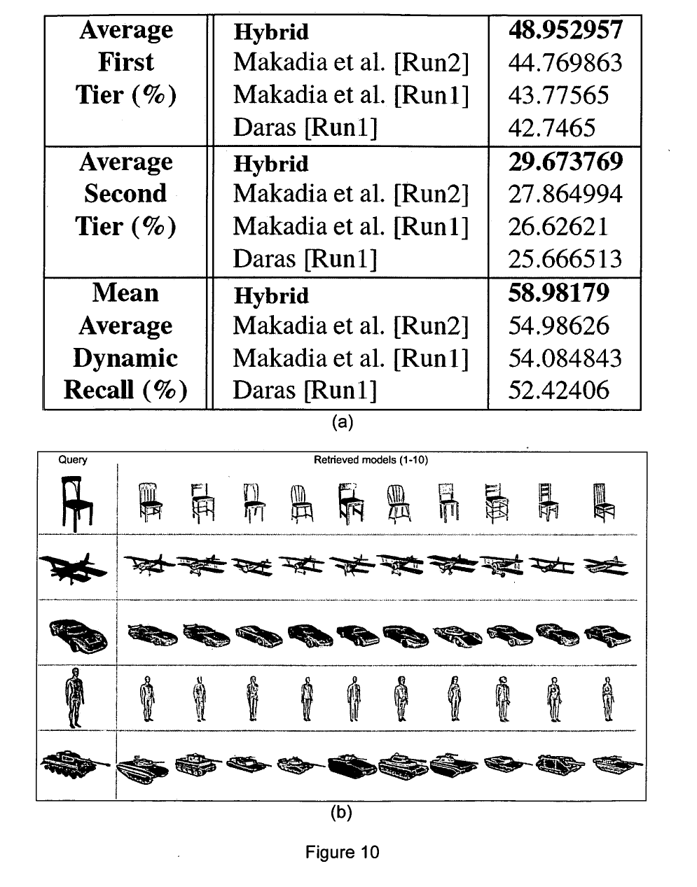

The performance of the proposed hybrid approach is additionally compared against the results from the SHape REtrieval Contest (SHREC 2006), see FIG. 10. The test database was the entire set (test and train) of the Princeton Shape Benchmark. 30 unknown query models were used and the performance was measured for each query individually. The scores of the proposed hybrid method were computed using the provided evaluation software for a set of quantitative performance measures that were used in SHREC 2006, such as the Average First Tier, Average Second Tier and Mean Average Dynamic Recall. A detailed description of these measures is given in the contest's specifications. The results of this comparison are shown in FIG. 10(a) where we compare the proposed hybrid approach against the top three ranked methods with respect to these quantitative measures. In FIG. 10(b) we show a subset of the queries used in the contest and the respective top 10 retrieved models using the proposed hybrid approach. According to this evaluation, the proposed hybrid approach is ranked first among all participating methods.

1. A hybrid content-based 3-dimensional (3D) model search method comprising the steps of: a. the input of a query 3D polygonal model; b. the extraction of a hybrid 3D shape descriptor from a 3D model; c. ranking of the 3D models of a dataset in descending order according to the similarity of their previously extracted hybrid 3D shape descriptors to the descriptor of the query 3D model.

2. The method of claim 1, wherein the extraction of the hybrid 3D shape descriptor of a 3D model comprises: a. the pose normalization of the 3D model; b. the extraction of a set of 2-dimensional (2D) and 3D features from a pose normalized 3D model that form a vector of numerical values.

3. The method of claim 2, wherein pose normalization of the 3D model is performed by normalizing the translation and/or scale and/or rotation; translation normalization is achieved by translating the 3D model by the vector that represents the difference between its centroid and a reference point; scale normalization is achieved by scaling the 3D model to a predefined size.

4. The method of claim 3, wherein rotation normalization is achieved by aligning the principal axes of a 3D model with the coordinate axes in a consistent way where the principal axes of the 3D model are determined using principal component analysis where the covariance matrix captures the surface area distribution of the 3D model and/or using principal component analysis where the covariance matrix captures the surface orientation distribution of the 3D model; the surface area of the 3D model is determined from the vertices of the polygons of the 3D model and the surface orientation is determined from the normal vectors of the polygons of the 3D model.

5. The method of claim 2, wherein the 2D features of the hybrid 3D shape descriptor of a 3D model are Fourier coefficients extracted from a number of depth image pairs of the 3D model and the 3D features are spherical harmonic coefficients extracted from a spherical function based representation of the 3D model; the set of 2D and 3D features are extracted for one or both of the two pose normalized versions of the 3D model and are combined linearly or by any other scheme to form the hybrid 3D shape descriptor of the 3D model.

6. The method of claim 5, wherein the 2D features of the hybrid 3D shape descriptor are extracted by: a. projecting the 3D model to the faces of a cube centered at the reference point of the 3D model; b. computing the difference and the sum of parallel projections; c. employing the Discrete Fourier Transform (DFT) on each projection and storing the norms of the Fourier coefficients; d. weighing the coefficients of a projection using the ranks of the principal axes that are parallel to the dimensions of the projection; e. normalizing the coefficients to the unit norm.

7. The method of claim 5, wherein the 3D features of the hybrid 3D shape descriptor are extracted by: a. computing a set of concentric spherical functions of increasing radius centered at the reference point of the 3D model, that capture the surface of the 3D model by a set of distributed points, in longitude and latitude; b. augmenting the previous representation with all collinear spherical function points that are closer to the reference point than their furthest collinear spherical function surface point; c. employing the Spherical Harmonics Transform (SHT) on each spherical function and storing the SHT coefficients; d. normalizing the coefficients to the unit norm.

8. The method of claim 1, wherein the ranking of the 3D models of a dataset for a particular query 3D model is determined by measuring the distance between the hybrid 3D shape descriptor of the query 3D model and the previously computed descriptors of all the 3D models of the dataset; the distance between two descriptors is measured by computing the L₁ distance or any other distance metric between the hybrid features of the corresponding rotation normalized versions of the two 3D models and taking the minimum or any other combination of the two scores; the 3D models of the dataset are ranked in increasing distance between their descriptor and the descriptor of the query.

9. A hybrid content-based 3D model search system comprising: a. a unit for the input of a query 3D polygonal model; b. a unit for the extraction of a hybrid 3D shape descriptor from a 3D model; c. a ranking unit that ranks the 3D models of a dataset in descending order according to their similarity of their previously extracted hybrid 3D shape descriptors to the descriptor of the query 3D model; d. a unit for the presentation of the ranked results which is a display device or a hard copy device.

10. A hybrid content-based 3D model search system as per claim 9 which runs on a single computer platform or in client-server mode, where the server is a computer containing the list of 3D models and/or their shape descriptors and the client is a computer which poses 3D model queries over a network and the hybrid 3D shape descriptor of the query 3D model is computed at the client or the server, as per claim 2.

11. The system of claim 9, wherein the unit for the input of a query 3D model is a user interface computer program that enables a user to submit a 3D model query.

12. The system of claim 9, wherein the unit for the extraction of the hybrid 3D shape descriptor of a 3D model comprises: a. a pose normalization section; b. a feature extraction section that extracts a set of 2D and 3D features from the 3D model that form a vector of numerical values.

13. The unit of claim 12, wherein the pose normalization section normalizes the translation and/or scale and/or rotation of the 3D model; translation normalization is achieved by translating the 3D model by the vector that represents the difference between its centroid and a reference point; scale normalization is achieved by scaling the 3D model to a predefined size.

14. The section of claim 13, wherein rotation normalization is achieved by aligning the principal axes of a 3D model with the coordinate axes in a consistent way where the principal axes of the 3D model are determined using principal component analysis where the covariance matrix captures the surface area distribution of the 3D model and/or using principal component analysis where the covariance matrix captures the surface orientation distribution of the 3D model; the surface area of the 3D model is determined from the vertices of the polygons of the 3D model and the surface orientation is determined from the normal vectors of the polygons of the 3D model.

15. The unit of claim 12, wherein the feature extraction section computes the 2D features set of the hybrid 3D shape descriptor of a 3D model, which are Fourier coefficients extracted from a number of depth image pairs of the 3D model and the 3D features set which are spherical harmonic coefficients extracted from a spherical function based representation of the 3D model; the set of 2D and 3D features are extracted for one or both of the two pose normalized versions of the 3D model and are combined linearly or by any other scheme to form the hybrid 3D shape descriptor of the 3D model.

16. The unit of claim 12, wherein the 2D features of the hybrid 3D shape descriptor are extracted by: a. projecting the 3D model to the faces of a cube centered at the reference point of the 3D model; b. computing the difference and the sum of parallel projections; c. employing the Discrete Fourier Transform (DFT) on each projection and storing the norms of the Fourier coefficients; d. weighing the coefficients of a projection using the ranks of the principal axes that are parallel to the dimensions of the projection; e. normalizing the coefficients to the unit norm.

17. The unit of claim 12, wherein the 3D features of the hybrid 3D shape descriptor are extracted by: a. computing a set of concentric spherical functions of increasing radius centered at the reference point of the 3D model, that capture the surface of the 3D model by a set of distributed points, in longitude and latitude; b. augmenting the previous representation with all collinear spherical function points that are closer to the reference point than their furthest collinear spherical function surface point; c. employing the Spherical Harmonics Transform (SHT) on each spherical function and storing the SHT coefficients; d. normalizing the coefficients to the unit norm.

18. The system of claim 9, wherein a ranking unit ranks the 3D models of a dataset for a particular query 3D model by measuring the distance between the hybrid 3D shape descriptor of the query 3D model and the previously computed descriptors of all the 3D models of the dataset; the distance between two descriptors is measured by computing the L₁ distance, or any other distance metric, between the hybrid features of the corresponding rotation normalized versions of the two 3D models and taking the minimum, or any other combination, of the two scores; the 3D models of the dataset are ranked in increasing distance of their descriptor compared to the descriptor of the query.
